(19) United States
(12) Patent Application Publication
(10) Pub. No.: US 2024/0174545 A1
(43) Pub. Date: May 30, 2024

(54) METHODS OF SEPARATING A SUBSTRATE

(71) Applicant: CORNING INCORPORATED, CORNING, NY (US)

(72) Inventors: Yuvanash Kasinathan, Germering (DE); Ralf Joachim Terbrueggen, Neuried (DE)

(21) Appl. No.: 18/505,608

(22) Filed: Nov. 9, 2023

Related U.S. Application Data
(60) Provisional application No. 63/428,902, filed on Nov. 30, 2022.

(51) Int. Cl. C03B 33/033; C03B 33/02

(52) U.S. Cl. CPC C03B 33/033; C03B 33/0222

(57) ABSTRACT

The disclosure relates to a method of laser processing a glass material, including: applying a layer of water to a top surface of a substrate support surface; positioning the glass material onto the substrate support surface, wherein the glass material comprises: a first surface, a second surface opposing the first surface, a plurality of perforations formed within the glass material along a cutting line, wherein the plurality of perforations extends through a thickness of the material from the first surface to the second surface, wherein the water enters into the plurality of perforations via capillary action; and applying a laser to the glass material at the cutting line to expand the water within the plurality of perforations to separate the material.

### CROSS-REFERENCE TO RELATED APPLICATIONS

This application claims the benefit of priority of U.S. Provisional Application Ser. No. 63/428,902 filed on Nov. 30, 2022, the content of which is relied upon and incorporated herein by reference in its entirety.

### FIELD OF THE DISCLOSURE

The disclosure relates to methods of cutting of materials, and more particularly to methods of cutting of glass materials using laser technology.

### BACKGROUND

Glass articles can be separated by forming a series of perforations within the glass article where the glass article will be separated. Cracks form between the perforations and additional external stress, such as mechanical or thermal, can be applied to separate the glass along the series of perforations. The residual strength of the glass article after forming the perforations is called the break resistance and can be regarded as a measure how much additional stress is necessary to achieve final separation. Achieving low break resistance allows mechanical separation (e.g. with a mechanical breaking device) and or thermal separation without causing collateral damage

Accordingly, there is a need for improved methods of cutting of glass materials using laser technology.

### SUMMARY OF THE DISCLOSURE

According to a first embodiment of the present disclosure, a method of laser processing a glass material includes: applying a layer of water to a top surface of a substrate support surface: positioning the glass material onto the substrate support surface, wherein the glass material comprises: a first surface, a second surface opposing the first surface, a plurality of perforations formed within the glass material along a cutting line, wherein the plurality of perforations extends through a thickness of the material from the first surface to the second surface, wherein the water enters into the plurality of perforations via capillary action: and applying a laser to the glass material at the cutting line to expand the water within the plurality of perforations to separate the material

A second embodiment of the present disclosure includes the first embodiment, wherein each perforation is a first distance from an adjacent perforation.

A third embodiment of the present disclosure includes the second embodiment, wherein the first distance is about 1 μm to about 15 μm.

A fourth embodiment of the present disclosure includes any of the first to third embodiments, further comprising translating one of the glass material or the laser to apply the laser to the plurality of perforations.

A fifth embodiment of the present disclosure includes any of the first to fourth embodiments, wherein the top surface of a substrate support surface is a porous material.

A sixth embodiment of the present disclosure includes any of the first to third embodiments, wherein applying the layer of water to the top surface of the substrate support surface further comprises applying a water-saturated material onto the top surface of the substrate support surface.

A seventh embodiment of the present disclosure includes any of the first to third embodiments, further comprising applying water to the cutting line prior to formation of the plurality of perforations to expand the first crack and applying water to the cutting line prior to applying one of chemical or mechanical energy to the glass material at the cutting line to separate the material.

According to an eighth embodiment of the present disclosure, a method of laser processing a glass material includes: forming a plurality of perforations within the glass material along a cutting line within a first process chamber, wherein the material comprises a first surface and a second surface opposing the first surface, wherein the perforation extends through a thickness of the material from the first surface to the second surface, and wherein a first crack is formed between adjacent perforations: applying water to the cutting line within a second process chamber: applying one of chemical or mechanical energy to the glass material at the cutting line within a third process chamber to separate the material

A ninth embodiment of the present disclosure includes the eighth embodiment, wherein each perforation is a first distance from an adjacent perforation.

A tenth embodiment of the present disclosure includes the ninth embodiment, wherein the first distance is about 1 μm to about 15 μm.

An eleventh embodiment of the present disclosure includes any of the eighth to tenth embodiments, further comprising: positioning the glass material within the first process chamber to form a plurality of perforations within the glass material along a cutting line; transferring the glass material from the first process chamber to the second process chamber to apply water to the cutting line after formation of the plurality of perforations to expand the first crack.

A twelfth embodiment of the present disclosure includes any of the eighth to tenth embodiments, further comprising positioning the glass material within the second process chamber to apply water to the cutting line prior to formation of the plurality of perforations; transferring the glass material to the first process chamber after applying water to the cutting line to form a plurality of perforations within the glass material along a cutting line.

A thirteenth embodiment of the present disclosure includes any of the eighth to tenth embodiments, further comprising positioning the glass material within the second process chamber to apply water to the cutting line prior to formation of the plurality of perforations; transferring the glass material to the first process chamber after applying water to the cutting line to form a plurality of perforations within the glass material along a cutting line; transferring the glass material to the second process chamber to apply water to the cutting line after formation of the plurality of perforations.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the Drawings:

FIG. 1 is a flowchart of an exemplary process for a method of laser processing a glass material, in accordance with some embodiments of the current disclosure:

FIG. 2 depicts an exemplary substrate support surface holding a glass material to be separated, in accordance with some embodiments of the current disclosure:

FIG. 3 depicts an exemplary an exemplary substrate support surface holding a glass material to be separated, in accordance with some embodiments of the current disclosure;

### DETAILED DESCRIPTION OF THE PREFERRED EMBODIMENTS

Additional features and advantages will be set forth in the detailed description which follows and will be apparent to those skilled in the art from the description or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone: B alone: C alone; A and B in combination: A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an endpoint of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

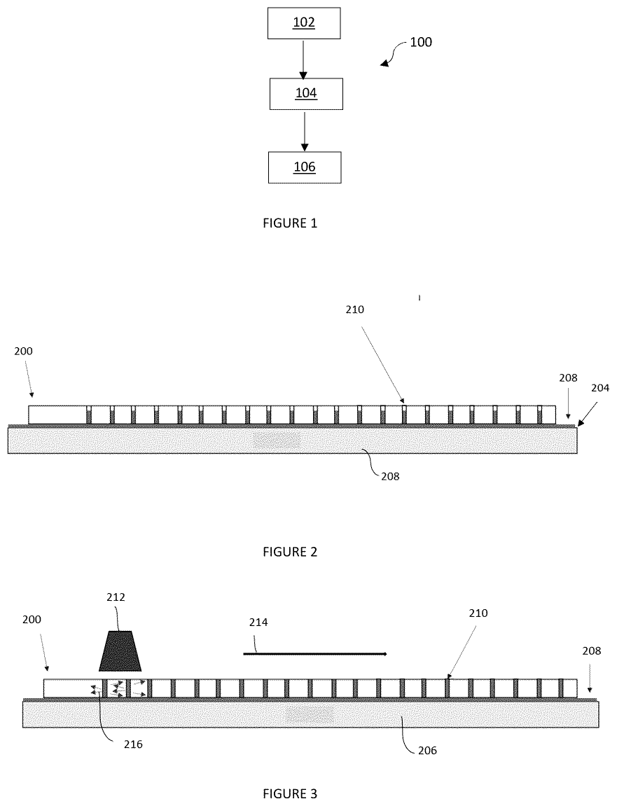

The method 100 of separating a material as depicted in FIG. 1, begins at 102 by applying a layer of water to a top surface of a substrate support surface. In embodiments, the layer of water may be applied directly to the top surface of the substrate support surface. In embodiments, the top surface of the substrate support surface is a porous material that is pre-soaked with water. In embodiments, a water-saturated material (e.g. paper, fleece) is positioned on the top surface of the substrate support surface.

Next at 104 and as depicted in FIG. 2, a glass material 200 is positioned onto a top surface 204 of the substrate support surface 206. The glass material is in contact with the water 208 on the top surface 204 of the substrate support surface 206. A plurality of perforations 210 is formed within the glass material 200 that is to be laser processed (i.e. separated). In embodiments, each perforation is a first distance from an adjacent perforation. In embodiments, the first distance is about 1 μm to about 15 μm. The water 208 enters into the plurality of perforations 210 via capillary action. In embodiments, the plurality of perforations is formed by a laser beam is applied to a first surface of the material that is to be laser processed. The laser beam generates an elongated material modification inside the material. In embodiments, the material is a brittle material such as glass. In embodiments, the material has a first surface and a second surface opposing the first surface. In embodiments, the laser beam forms an elongated focal line extending into the material. In an alternative embodiment, the laser beam forms multiple local focal spots produced by self-focusing along the laser beam direction. The laser energy modifies the material to form a damage line in the material. The damage line produces a perforation inside the material. The material and/or laser is moved relative to each other so that a plurality of perforations are generated along the cutting line (i.e. a line along which the material is to be separated). The damage of the modified material around the perforations and, in particular, between two adjacent perforations creates tension inside the material which creates at least a first crack between two adjacent perforations.

In embodiments, the material to be processed is irradiated with an ultra-short pulsed (pulse width less than 100 psec) laser beam (at wavelengths at or below 1064 nm) that is condensed into a high aspect ratio line focus that penetrates through the thickness of the substrate. Within this volume of high energy density the material is modified via nonlinear effects. It is important to note that without this high optical intensity, nonlinear absorption is not triggered. Below this intensity threshold, the material is transparent to the laser radiation and remains in its original state. By scanning the laser over a desired line or path a narrow defect line or contour or path (a few microns wide) is created and defines the line of separation.

The laser source can create multi-photon absorption (MPA) in substantially transparent materials such as glass composite workpieces. MPA is the simultaneous absorption of two or more photons of identical or different frequencies in order to excite a molecule from one state (usually the ground state) to a higher energy electronic state (ionization). The energy difference between the involved lower and upper states of the molecule is equal to the sum of the energies of the two photons. MPA, also called induced absorption, can be a second-order or third-order process (or higher order), for example, that is several orders of magnitude weaker than linear absorption. It differs from linear absorption in that the strength of second-order induced absorption can be proportional to the square of the light intensity, for example, and thus it is a nonlinear optical process.

This laser cutting process makes use of an ultra-short pulse laser in combination with optics that generates a focal line to fully perforate the body of a range of glass compositions. In some embodiments, the pulse duration of the individual pulses is in a range of between greater than about 1 picoseconds and less than about 100 picoseconds, such as greater than about 5 picoseconds and less than about 20 picoseconds, and the repetition rate of the individual pulses can be in a range of between about 1 kHz and 4 MHz, such as in a range of between about 10 kHz and 650 kHz.

In addition to a single pulse operation at the aforementioned individual pulse repetition rates, the pulses can be produced in bursts of two pulses, or more (such as, for example, 3 pulses, 4, pulses, 5 pulses, 10 pulses, 15 pulses, 20 pulses, or more) separated by a duration between the individual pulses within the burst that is in a range of between about 1 nsec and about 50 nsec, for example, 10 to 30 nsec, such as about 20 nsec, and the burst repetition frequency can be in a range of between about 1 kHz and about 200 kHz. (Bursting or producing pulse bursts is a type of laser operation where the emission of pulses is not in a uniform and steady stream but rather in tight clusters of pulses.) The pulse burst laser beam can have a wavelength selected such that the material is substantially transparent at this wavelength. The average laser power per burst measured at the material can be greater than 40 microJoules per mm thickness of material, for example between 40 microJoules/mm and 2500 microJoules/mm, or between 500 and 2250 microJoules/mm.

The glass is moved relative to the laser beam (or the laser beam is translated relative to the glass) to create perforated lines. The laser creates hole-like defect zones (or damage tracks, or defect lines) that penetrate the full depth the glass.

There are several methods to create the perforation. The optical method of forming the line focus can take multiple forms, using donut shaped laser beams and spherical lenses, axicon lenses, diffractive elements, or other methods to form the linear region of high intensity. The type of laser (picosecond, femtosecond, etc.) and wavelength (IR, green, UV, etc.) can also be varied, as long as sufficient optical intensities are reached to create breakdown of the substrate material in the region of focus to create breakdown of the substrate material or glass workpiece, through nonlinear optical effects. Preferably, the laser is a pulse burst laser which allows for control of the energy deposition with time by adjusting the number of pulses within a given burst.

Next at 106, and as depicted in FIG. 3 additional energy 212 is applied to the material along and/or at the cutting line to separate the material at the cutting line. In embodiments, the thermal energy is provided by a CO₂ laser beam to locally heat the material along the cutting line. The thermal energy generates a thermal stress in the material along the cutting line. Application of the CO₂ laser beam heats up the water in the perforations, causing them to expand and create the tension 216 needed for crack propagation along the perforations. One of the glass material or the CO₂ laser beam 212 is translated 214 relative to the other of the glass material or the CO₂ laser beam 212 to apply the CO₂ laser beam 212 to the plurality of perforations. The crack propagation process leads to separation of the material along the cutting line.

The optional CO₂ laser separation is achieved, for example, with a defocused continuous wave (cw) laser emitting at 10.6 microns and with power adjusted by controlling its duty cycle. Focus change (i.e., extent of defocusing up to and including focused spot size) is used to vary the induced thermal stress by varying the spot size. Defocused laser beams include those laser beams that produce a spot size larger than a minimum, diffraction-limited spot size on the order of the size of the laser wavelength. For example, CO₂ lasers with spot sizes of 1 to 20 mm, e.g., 1 to 12 mm, 3 to 8 mm can be utilized, for example a CO₂ 10.6 μm wavelength laser can form beams with these spot sizes on the perforated glass. Some examples of CO₂ laser spot diameters are: 2 mm, 5 mm, 7 mm, 10 mm, and 20 mm. The exact power levels, spot sizes, and scanning speeds chosen within the specified ranges may depend on the material use, its thickness, coefficient of thermal expansion (CTE), elastic modulus, since all of these factors influence the amount of thermal stress imparted by a specific rate of energy deposition at a given spatial location.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

What is claimed is:

1. A method of laser processing a glass material, comprising:
applying a layer of water to a top surface of a substrate support surface;
positioning the glass material onto the substrate support surface, wherein the glass material comprises: a first surface, a second surface opposing the first surface, a plurality of perforations formed within the glass material along a cutting line, wherein the plurality of perforations extends through a thickness of the material from the first surface to the second surface, wherein the water enters into the plurality of perforations via capillary action; and
applying a laser to the glass material at the cutting line to expand the water within the plurality of perforations to separate the material.

2. The method of claim 1, wherein each perforation is a first distance from an adjacent perforation.

3. The method of claim 2, wherein the first distance is about 1 μm to about 15 μm.

4. The method of claim 1, further comprising translating one of the glass material or the laser to apply the laser to the plurality of perforations.

5. The method of claim 1, wherein the top surface of a substrate support surface is a porous material.

6. The method of claim 1, wherein applying the layer of water to the top surface of the substrate support surface further comprises applying a water-saturated material onto the top surface of the substrate support surface.
